(19) United States
(12) Patent Application Publication
(10) Pub. No.: US 2021/0280074 A1
(43) Pub. Date: Sep. 9, 2021

(54) CONFIRMATION OF SUCCESSFUL DELIVERY BY AN UNMANNED AERIAL VEHICLE (UAV)

(71) Applicant: SKYGRID, LLC, AUSTIN, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US)

(21) Appl. No.: 17/120,168

(22) Filed: Dec. 13, 2020

Related U.S. Application Data
(60) Provisional application No. 62/947,847, filed on Dec. 13, 2019.

(51) Int. Cl. G08G 5/00; B64C 39/02; H04L 9/00; H04L 9/32

(52) U.S. Cl. CPC G08G 5/0047; B64C 39/024; H04L 2209/38; H04L 9/3236; B64C 2201/123; H04L 9/006

(57) ABSTRACT

Methods and devices for confirmation of successful delivery by an unmanned aerial vehicle (UAV) are disclosed. A UAV is configured to navigate to a delivery destination, authenticate a receiving zone at the delivery destination, release, in dependence upon authentication of the receiving zone, the package into the receiving zone, capture, by a camera of the UAV, an image of the receiving zone, and generate delivery confirmation data including the image the receiving zone. A recipient device is configured to detect, by the device disposed in a receiving zone for receiving a package, a UAV in proximity to a receiving zone, authenticate the UAV, detect delivery of the package in the receiving zone, capture, by a camera of the device, an image of the package, and generate delivery confirmation data including the image the package and location data obtained from a GPS sensor in the device.

### CROSS-REFERENCE TO RELATED APPLICATIONS

This application is a non-provisional application for patent entitled to a filing date and claiming the benefit of earlier-filed U.S. Provisional Patent Application Ser. No. 62/947,847, filed Dec. 13, 2019.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to ensure to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under 400 feet above ground level (AGL)) in airspace where FAA air traffic services are not provided. However, a framework that extends beyond the 400 feet AGL limit is needed. For example, unmanned aircraft that would be used by package delivery services and air taxis may need to travel at altitudes above 400 feet. Such a framework requires technology that will allow the FAA to safely regulate unmanned aircraft.

### SUMMARY

In a particular implementation, a method of confirmation of successful delivery by a UAV is disclosed. The method includes comprising navigating, by a UAV carrying a package, to a delivery destination, authenticating, by the UAV, a receiving zone at the delivery destination, releasing, by the UAV in dependence upon authentication of the receiving zone, the package into the receiving zone, capturing, by a camera of the UAV, an image of the receiving zone, and generating, by the UAV, delivery confirmation data including the image the receiving zone.

In some embodiments, authenticating, by the UAV, the receiving zone at the delivery destination includes reading, by the camera, a machine-readable optical label located in the receiving zone, the optical label including at least one of a Quick Response (QR) code and an April Tag, deriving an identification code from the optical label, and comparing the identification code to an assigned code associated with the package. In other embodiments, authenticating, by the UAV, the receiving zone at the delivery destination includes establishing a communication channel with a recipient device disposed in the receiving zone, performing, through the communication channel, a public key infrastructure (PKI) handshake using a public key of a public/private key pair of the recipient device, and exchanging identification data with the recipient device using a session key established by the PKI handshake.

Exchanging identification data with the recipient device using the session key established by the PKI handshake may include sending delivery identification data including at least one of a package identifier, a merchant identifier, a parcel delivery service identifier, and a UAV identifier to the recipient device. Exchanging identification data with the recipient device using the session key established by the PKI handshake may include sending receiving recipient device identification data including at least one of a recipient device identifier, one or more names of registered recipients, location data, and a code word associated with the package.

Generating, by the UAV, the delivery confirmation data including the image of the package in the receiving zone may include generating, based on the recipient device identification data, a delivery confirmation report, appending to the delivery confirmation report an image file including an image of the package in the receiving zone, and transmitting the delivery confirmation report to at least one of a UAV controller and a UAV server.

Generating, by the UAV, the delivery confirmation data including the image of the package in the receiving zone may also include storing the delivery confirmation report in a block of a blockchain data structure. Storing the delivery confirmation report in the block of the blockchain data structure may include signing the delivery confirmation report using a private key of the UAV.

In some embodiments, navigating to the delivery destination may further include landing on a landing pad of a recipient device disposed in the receiving zone. Also in some embodiments, if authentication of the receiving zone fails, the method includes capturing an image of the receiving zone without releasing the package; and wherein the delivery confirmation data including the image of the receiving zone indicates that the receiving zone failed authentication and that the package was not delivered.

In another implementation, a device for confirmation of successful delivery by a UAV is disclosed. The device includes a processor and a memory storing instructions. In this implementation, the instructions are executable by the processor to navigate, carrying a package, to a delivery destination, authenticate, a receiving zone at the delivery destination, release, in dependence upon authentication of the receiving zone, the package into the receiving zone, capture, by a camera of the UAV, an image of the receiving zone, and generate delivery confirmation data including the image the receiving zone.

In another particular implementation, another method of confirmation of successful delivery by a UAV is disclosed. The method includes detecting, by the recipient device disposed in a receiving zone for receiving a package, an unmanned aerial vehicle (UAV) in proximity to a receiving zone, authenticating, by the recipient device, the UAV, detecting, by the recipient device, delivery of the package in the receiving zone, capturing, by a camera of the recipient device, an image of the package, and generating, by the recipient device, delivery confirmation data including the image the package and location data obtained from a GPS sensor in the recipient device.

In some embodiments authenticating, by the recipient device, the UAV may include reading, by the camera, a machine-readable optical label located on the UAV, the optical label including at least one of a Quick Response (QR) code and an April Tag, deriving an identification code from the optical label, and comparing the identification code to a list of known identification codes. In other embodiments, authenticating, by the recipient device, the UAV may also include establishing a communication channel with the UAV, performing, through the communication channel, a public key infrastructure (PKI) handshake using a public/private key pair of the recipient device, and exchanging identification data with the UAV using a session key established by the PKI handshake. Exchanging identification data with the UAV using the session key established by the PKI handshake may include receiving delivery identification data including at least one of a package identifier, a merchant identifier, a parcel delivery service identifier, and a UAV identifier from the UAV, and sending recipient device identification data including at least one of a recipient device identifier, one or more names of registered recipients, location data, and a code word associated with the package to the UAV.

In some embodiments, generating, by the recipient device, the delivery confirmation data including the image of the package and location data may include generating, based on the delivery identification data, a delivery confirmation report, appending to the delivery confirmation report an image file including the image of the package and the location data, and transmitting the delivery confirmation report to a recipient of the package.

Generating, by the recipient device, the delivery confirmation data including the image of the package and the location data may also include storing the delivery confirmation report in a block of a blockchain data structure. Storing the delivery confirmation report to the blockchain data structure may include signing the delivery confirmation report using the private key of the recipient device.

In some embodiments, capturing, by the camera of the recipient device, the image of the package includes reading, by the camera, a machine-readable optical label located on the package, the optical label including at least one of a bar code, a Quick Response (QR) code and an April Tag, deriving an identification code from the optical label, and comparing the identification code to an identification code associated with the package.

In some embodiments, detecting, by the recipient device disposed in a receiving zone for receiving a package, the UAV in proximity to the receiving zone includes detecting, by a sensor in the recipient device, that the UAV has landed on a landing pad of the recipient device.

In another implementation, another device for confirmation of successful delivery by a UAV is disclosed. The device includes a processor and a memory storing instructions. In this implementation, the instructions are executable by the processor to detect, by the recipient device disposed in a receiving zone for receiving a package, an unmanned aerial vehicle (UAV) in proximity to a receiving zone, authenticate, by the recipient device, the UAV, detect, by the recipient device, delivery of the package in the receiving zone, capture, by a camera of the recipient device, an image of the package, and generate, by the recipient device, delivery confirmation data including the image the package and location data obtained from a GPS sensor in the recipient device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system for confirmation of successful delivery by a UAV;

FIG. 2 is a block diagram illustrating another implementation of a system for confirmation of successful delivery by a UAV;

FIG. 3 is a block diagram illustrating a particular implementation of blockchain-based operations used by the systems of FIGS. 1-2;

FIG. 4 is a block diagram illustrating a particular implementation of a system for confirmation of successful delivery by a UAV;

FIG. 5 is a block diagram illustrating another implementation of a system for confirmation of successful delivery by a UAV;

FIG. 6 is a flowchart to illustrate a particular implementation of a method for confirmation of successful delivery by a UAV;

FIG. 7 is a flowchart to illustrate another implementation of a method for confirmation of successful delivery by a UAV;

FIG. 8 is a flowchart to illustrate another implementation of a method for confirmation of successful delivery by a UAV;

FIG. 9 is a flowchart to illustrate another implementation of a method for confirmation of successful delivery by a UAV;

FIG. 10 is a flowchart to illustrate another implementation of a method for confirmation of successful delivery by a UAV;

FIG. 11 is a flowchart to illustrate another implementation of a method for confirmation of successful delivery by a UAV;

FIG. 12 is a flowchart to illustrate another implementation of a method for confirmation of successful delivery by a UAV;

FIG. 13 is a flowchart to illustrate another implementation of a method for confirmation of successful delivery by a UAV;

FIG. 14 is a flowchart to illustrate another implementation of a method for confirmation of successful delivery by a UAV;

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

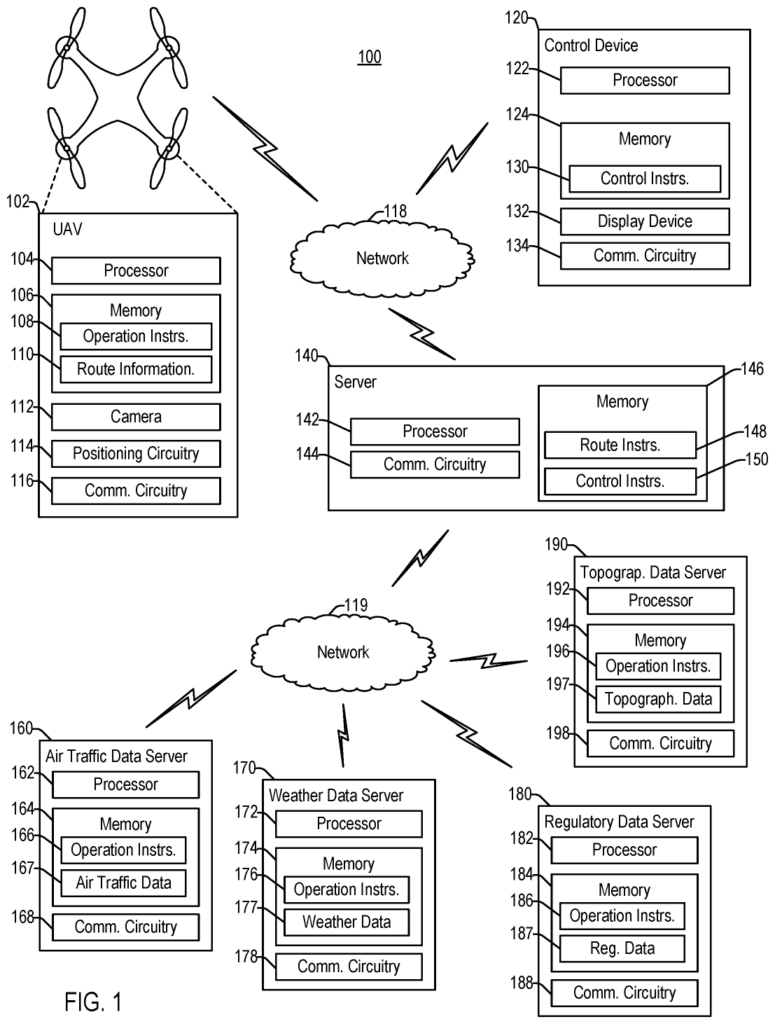

Exemplary methods, apparatuses, and computer program products for route planning for an UAV in accordance with the present invention are described with reference to the accompanying drawings, beginning with FIG. 1. FIG. 1 sets forth a diagram of a system (100) configured for route planning for an UAV according to embodiments of the present disclosure. The system (100) of FIG. 1 includes an unmanned aerial vehicle (UAV) (102), a control device (120), a server (140), an air traffic data server (160), a weather data server (170), a regulatory data server (180), and a topographical data server (190).

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such passenger drones (drone taxi, flying taxi, or pilotless helicopter) carry human passengers.

For ease of illustration, the UAV (102) is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV (102) includes a processor (104) coupled to a memory (106), a camera (112), positioning circuitry (114), and communication circuitry (116). The communication circuitry (116) includes a transmitter and a receiver or a combination thereof (e.g., a transceiver). In a particular implementation, the communication circuitry (116) (or the processor (104)) is configured to encrypt outgoing message(s) using a private key associated with the UAV (102) and to decrypt incoming message(s) using a public key of a device (e.g., the control device (120) or the server (140)) that sent the incoming message(s). Thus, in this implementation, communications between the UAV (102), the control device (120), and the server (140) are secure and trustworthy (e.g., authenticated).

The camera (112) is configured to capture image(s), video, or both, and can be used as part of a computer vision system. For example, the camera (112) may capture images or video and provide the video or images to a pilot of the UAV (102) to aid with navigation. Additionally, or alternatively, the camera (112) may be configured to capture images or video to be used by the processor (104) during performance of one or more operations, such as a landing operation, a takeoff operation, or object/collision avoidance, as non-limiting examples. Although a single camera (112) is shown in FIG. 1, in alternative implementations more and/or different sensors may be used (e.g., infrared, LIDAR, SONAR, etc.).

The positioning circuitry (114) is configured to determine a position of the UAV (102) before, during, and/or after flight. For example, the positioning circuitry (114) may include a global positioning system (GPS) interface or sensor that determines GPS coordinates of the UAV (102). The positioning circuitry (114) may also include gyroscope(s), accelerometer(s), pressure sensor(s), other sensors, or a combination thereof, that may be used to determine the position of the UAV (102).

The processor (104) is configured to execute instructions stored in and retrieved from the memory (106) to perform various operations. For example, the instructions include operation instructions (108) that include instructions or code that cause the UAV (102) to perform flight control operations. The flight control operations may include any operations associated with causing the UAV to fly from an origin to a destination. For example, the flight control operations may include operations to cause the UAV to fly along a designated route (e.g., based on route information (110), as further described herein), to perform operations based on control data received from one or more control devices, to take off, land, hover, change altitude, change pitch/yaw/roll angles, or any other flight-related operations. The UAV (102) may include one or more actuators, such as one or more flight control actuators, one or more thrust actuators, etc., and execution of the operation instructions (108) may cause the processor (104) to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The memory (106) also includes route information (110) that indicates a flight path for the UAV (102) to follow. For example, the route information (110) may specify a starting point (e.g., an origin) and an ending point (e.g., a destination) for the UAV (102). Additionally, the route information may also indicate a plurality of waypoints, zones, areas, regions between the starting point and the ending point.

The route information (110) may also indicate a corresponding set of control devices for various points, zones, regions, areas of the flight path. The indicated sets of control devices may be associated with a pilot (and optionally one or more backup pilots) assigned to have control over the UAV (102) while the UAV (102) is in each zone. The route information (110) may also indicate time periods during which the UAV is scheduled to be in each of the zones (and thus time periods assigned to each pilot or set of pilots).

The control device (120) includes a processor (122) coupled to a memory (124), a display device (132), and communication circuitry (134). The display device (132) may be a liquid crystal display (LCD) screen, a touch screen, another type of display device, or a combination thereof. The communication circuitry (134) includes a transmitter and a receiver or a combination thereof (e.g., a transceiver). In a particular implementation, the communication circuitry (134) (or the processor (122)) is configured to encrypt outgoing message(s) using a private key associated with the control device (120) and to decrypt incoming message(s) using a public key of a device (e.g., the UAV (102) or the server (140)) that sent the incoming message(s). Thus, in this implementation, communication between the UAV (102), the control device (120), and the server (140) are secure and trustworthy (e.g., authenticated).

The processor (122) is configured to execute instructions from the memory (124) to perform various operations. The instructions also include control instructions (130) that include instructions or code that cause the control device (120) to generate control data to transmit to the UAV (102) to enable the control device (120) to control one or more operations of the UAV (102) during a particular time period, as further described herein.

The server (140) includes a processor (142) coupled to a memory (146), and communication circuitry (144). The communication circuitry (144) includes a transmitter and a receiver or a combination thereof (e.g., a transceiver). In a particular implementation, the communication circuitry (144) (or the processor (142)) is configured to encrypt outgoing message(s) using a private key associated with the server (140) and to decrypt incoming message(s) using a public key of a device (e.g., the UAV (102) or the control device (120)) that sent the incoming message(s). Thus, in this implementation, communication between the UAV (102), the control device (120), and the server (140) are secure and trustworthy (e.g., authenticated).

The processor (142) is configured to execute instructions from the memory (146) to perform various operations. The instructions include route instructions (148) comprising computer program instructions for aggregating data from disparate data servers, virtualizing the data in a map, generating a cost model for paths traversed in the map, and autonomously selecting the optimal route for the UAV based on the cost model. For example, the route instructions (148) are configure to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions (148) are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions (148) may also include instructions for storing the parameters of the selected optimal flight path as route information (110). For example, the route information may include waypoints marked by GPS coordinates, arrival times for waypoints, pilot assignments. The server (140) may be configured to transmit the route information (110) to the UAV (102).

The instructions may also include control instructions (150) that include instructions or code that cause the server (140) to generate control data to transmit to the UAV (102) to enable the server (140) to control one or more operations of the UAV (102) during a particular time period, as further described herein.

The UAV (102), the control device (120), and server (140) are communicatively coupled via a network (118). For example, the network (118) may include a satellite network or another type of network that enables wireless communication between the UAV (102), the control device (120), and the server (140). In an alternative implementation, the control device (120), the server (140) communicate with the UAV (102) via separate networks (e.g., separate short range networks.

In some situations, minimal (or no) manual control of the UAV (102) may be performed, and the UAV (102) may travel from the origin to the destination without incident. However, in some situations, one or more pilots may control the UAV (102) during a time period, such as to perform object avoidance or to compensate for an improper UAV operation. In some situations, the UAV (102) may be temporarily stopped, such as during an emergency condition, for recharging, for refueling, to avoid adverse weather conditions, responsive to one or more status indicators from the UAV (102), etc. In some implementations, due to the unscheduled stop, the route information (110) may be updated (e.g., via a subsequent blockchain entry, as further described herein) by route instructions (148) executing on the UAV (102), the control device (120), or the server (140)). The updated route information may include updated waypoints, updated time periods, and updated pilot assignments.

In a particular implementation, the route information is exchanged using a blockchain data structure. The blockchain data structure is shared in a distributed manner across a plurality of devices of the system (100), such as the UAV (102), the control device (120), the server (140), and any other control devices or UAVs in the system (100). In a particular implementation, each of the devices of the system (100) stores an instance of the blockchain data structure in a local memory of the respective device. In other implementations, each of the devices of the system (100) stores a portion of the shared blockchain data structure and each portion is replicated across multiple of the devices of the system (100) in a manner that maintains security of the shared blockchain data structure as a public (i.e., available to other devices) and incorruptible (or tamper evident) ledger.

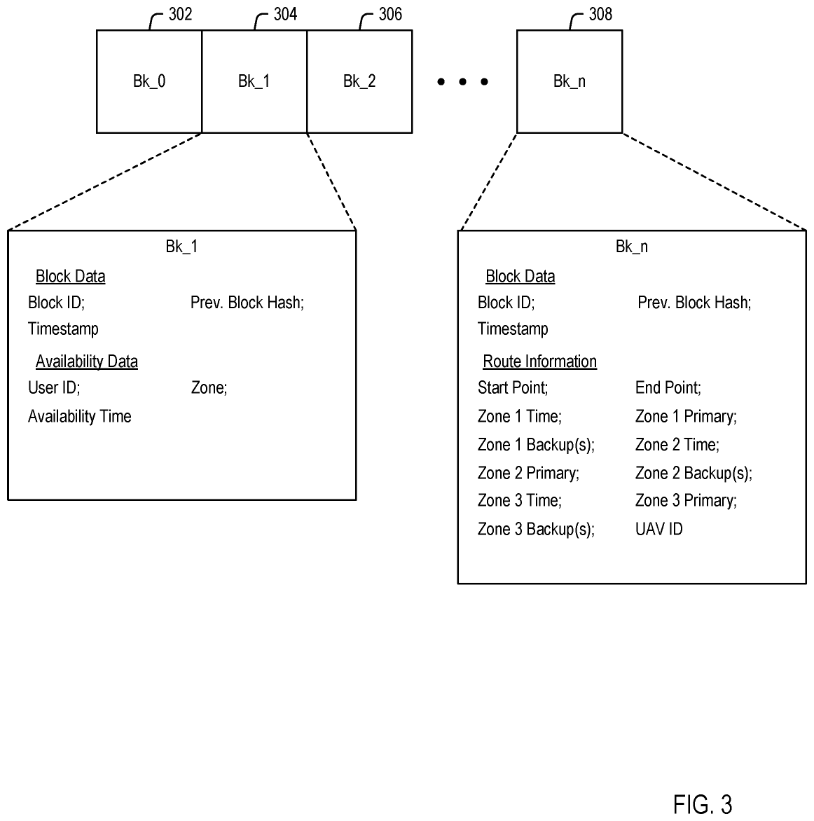

The blockchain data structure may include, among other things, route information associated with the UAV (102). For example, the route information (110) may be used to generate blocks of the blockchain data structure. A sample blockchain data structure (300) is illustrated in FIG. 3. Each block of the blockchain data structure (300) includes block data and other data, such as availability data or route data.

The block data of each block includes information that identifies the block (e.g., a block ID) and enables the devices of the system (100) to confirm the integrity of the blockchain data structure (300). For example, the block data also includes a timestamp and a previous block hash. The timestamp indicates a time that the block was created. The block ID may include or correspond to a result of a hash function (e.g., a SHA256 hash function, a RIPEMD hash function, etc.) based on the other information (e.g., the availability data or the route data) in the block and the previous block hash (e.g., the block ID of the previous block). For example, in FIG. 3, the blockchain data structure (300) includes an initial block (Bk_0) (302) and several subsequent blocks, including a block Bk_1 (304), a block Bk_2 (306), and a block Bk_n (308).

The initial block Bk_0 (302) includes an initial set of availability data or route data, a timestamp, and a hash value (e.g., a block ID) based on the initial set of availability data or route data. The block Bk_1 (304) also includes a hash value based on the other data of the block Bk_1 (304) and the previous hash value from the initial block Bk_0 (302). Similarly, the block Bk_2 (306) other data and a hash value based on the other data of the block Bk_2 (306) and the previous hash value from the block Bk_1 (304). The block Bk_n (308) includes other data and a hash value based on the other data of the block Bk_n (308) and the hash value from the immediately prior block (e.g., a block Bk_n-1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system (100).

In addition to the block data, each block of the blockchain data structure (300) includes availability data or route data. For example, the block Bk_1 (104) includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_n (408) includes route information that includes a UAV ID, a start point, an end point, waypoints, GPS coordinates, zone markings, time periods, primary pilot assignments, and backup pilot assignments for each zone associated with the route.

In a particular embodiment, the server (140) includes software that is configured to receive telemetry information from an airborne UAV and track the UAV's progress and status. The server (140) is also configured to transmit in-flight commands to the UAV. Operation of the control device and the server may be carried out by some combination of a human operator and autonomous software (e.g., artificial intelligence (AI) software that is able to perform some or all of the operational functions of a typical human operator pilot).

In a particular embodiment, the route instructions (148) cause the server (140) to plan a flight path, generate route information, dynamically reroute the flight path and update the route information based on data aggregated from a plurality of data servers. For example, the server (140) may receive air traffic data (167) over the network (119) from an air traffic data server (160), weather data (177) from a weather data server (170), regulatory data (187) from a regulatory data server (180), and topographical data (197) from a topographic data server (190). It will be recognized by those of skill in the art that other data servers useful in-flight path planning of a UAV may also provide data to the server (140) over the network (101) or through direct communication with the server (140).

The air traffic data server (160) may include a processor (162), memory (164), and communication circuitry (168). The memory (164) of the air traffic data server (160) may include operating instructions (166) that when executed by the processor (162) cause the processor to provide the air traffic data (167) about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server (170) may include a processor (172), memory (174), and communication circuitry (178). The memory (174) of the weather data server (170) may include operating instructions (176) that when executed by the processor (172) cause the processor to provide weather data (177) about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server (180) may include a processor (182), memory (184), and communication circuitry (188). The memory (184) of the weather data server (180) may include operating instructions (186) that when executed by the processor (182) cause the processor provide regulatory data (187) about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographical data server (190) may include a processor (192), memory (194), and communication circuitry (198). The memory (194) of the topographical data server (190) may include operating instructions (196) that when executed by the processor (192) cause the processor to provide topographical data about terrain, places, structures, transportation, boundaries, hydrography, orthoimagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server (140) may aggregate data from the data servers (160, 170, 180, 190) using application program interfaces (APIs), syndicated feeds and eXtensible Markup Language (XML), natural language processing, JavaScript Object Notation (JSON) servers, or combinations thereof. Updated data may be pushed to the server (140) or may be pulled on-demand by the server (140). Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, orthoimagery, land cover, and elevation. Readers of skill in the art will appreciate that various governmental and non-governmental entities may act as data servers and provide access to that data using APIs, JSON, XML, and other data formats.

Readers of skill in the art will realize that the server (140) can communicate with a UAV (102) using a variety of methods. For example, the UAV (102) may transmit and receive data using Cellular, 5G, Sub1GHz, SigFox, WiFi networks, or any other communication means that would occur to one of skill in the art.

The network (119) may comprise one or more Local Area Networks (LANs), Wide Area Networks (WANs), cellular networks, satellite networks, internets, intranets, or other networks and combinations thereof. The network (119) may comprise one or more wired connections, wireless connections, or combinations thereof.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

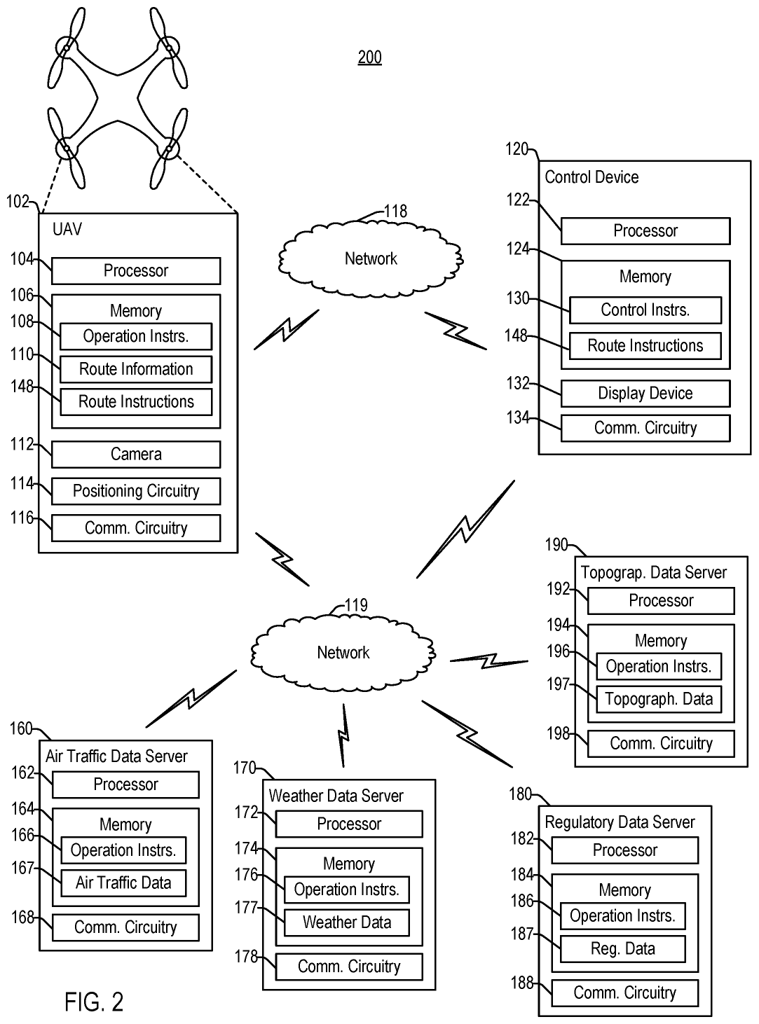

For further explanation, FIG. 2 sets forth a block diagram illustrating another implementation of a system (200) for confirmation of successful delivery by a UAV. Specifically, the system (200) of FIG. 2 shows an alternative configuration in which one or both of the UAV (102) and the server (140) may include route instructions (148) for generating route information. In this example, instead of relying on a server (140) to generate the route information, the UAV (102) and the control device (120) may retrieve and aggregate the information from the various data sources (e.g., the air traffic data server (160), the weather data server (170), the regulatory data server (180), and the topographical data server (190)). As explained in FIG. 1, the route instructions may be configured to use the aggregated information from the various source to plan and select a flight path for the UAV (102).

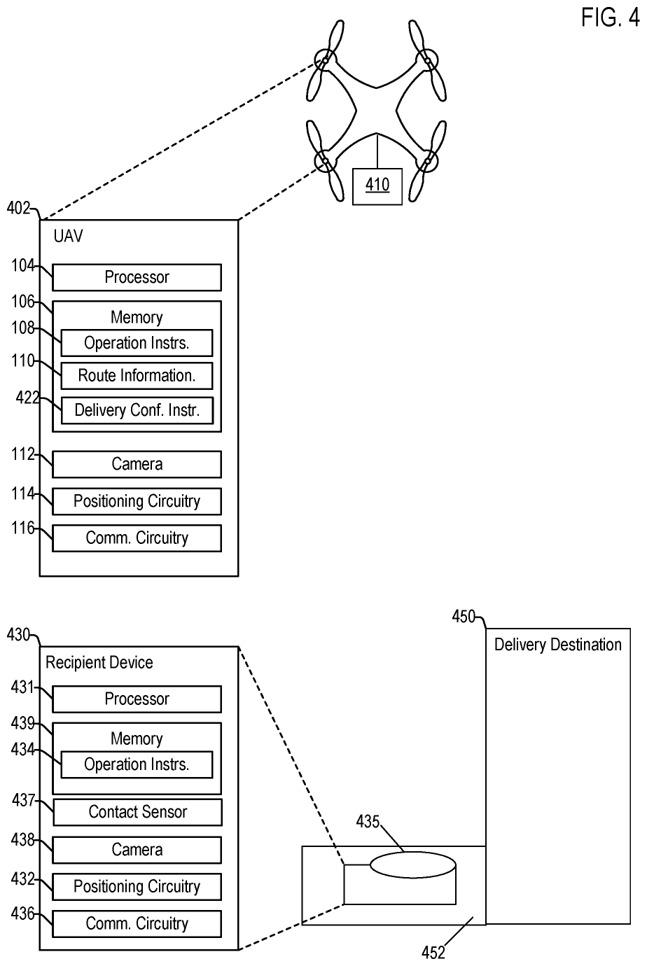

For further explanation, FIG. 4 sets forth a block diagram illustrating a system (400) for confirmation of successful delivery by a UAV that includes a delivery destination (450) of a package (410) that includes a receiving zone (452) for receiving delivery of the package (452). The receiving zone (452) may be, for example, a box, bag, locker, or other receptacle for receiving the package (410), or an area delimited by an optical marker or invisible geofence in which the package (410) is received.

The system (400) of FIG. 4 further includes a UAV (402) that is similar in configuration to the UAV (102) described with reference to FIG. 1. In addition to the components described with reference to FIG. 1, the UAV (402) further includes delivery confirmation instructions (422) stored in the memory (106) and executable by the processor (104) to navigate the UAV (402), carrying a package (410), to the delivery destination (450), authenticate the receiving zone (452) at the delivery destination, release, in dependence upon authentication of the receiving zone (452), the package into the receiving zone (452), capture, by the camera (112), an image of the receiving zone (452), and generate delivery confirmation data including the image the receiving zone (452).

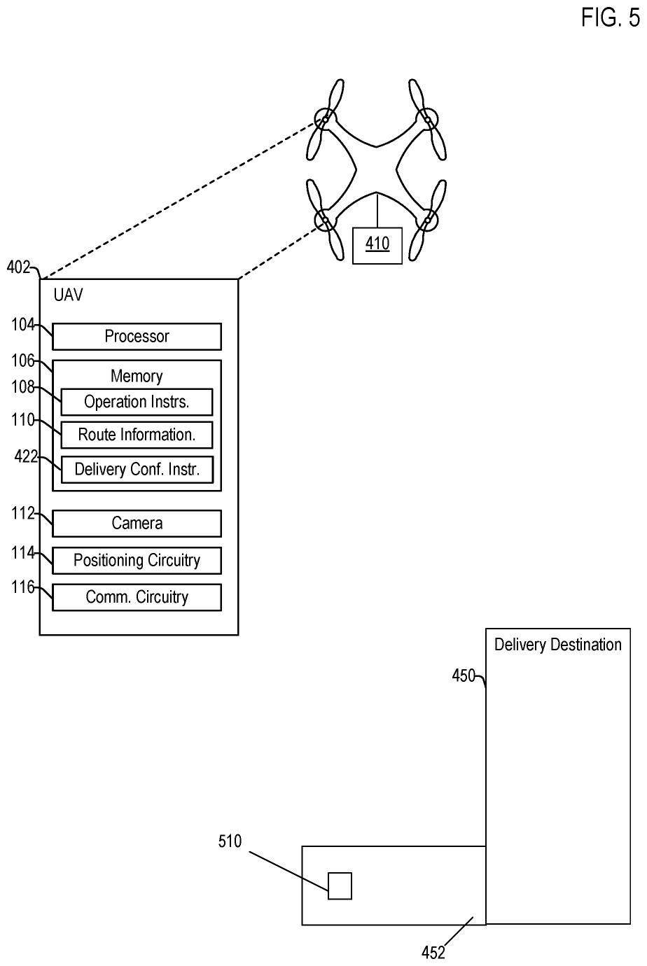

In some embodiments, the delivery confirmation instructions (422) further include instructions for reading, by the camera (112), a machine-readable optical label (510) (see FIG. 5) located in the receiving zone (452), the optical label (510) including at least one of a Quick Response (QR) code and an April Tag, deriving an identification code from the optical label (510), and comparing the identification code to an assigned code associated with the package (410). In other embodiments, the delivery confirmation instructions (422) include instructions for establishing a communication channel with a recipient device (430) (described below) disposed in the receiving zone, performing, through the communication channel, a public key infrastructure (PKI) handshake using a public key of a public/private key pair of the recipient device, and exchanging identification data with the recipient device using a session key established by the PKI handshake. Exchanging identification data with the recipient device (430) using the session key established by the PKI handshake may include sending delivery identification data including at least one of a package identifier, a merchant identifier, a parcel delivery service identifier, and a UAV identifier to the recipient device. Exchanging identification data with the recipient device using the session key established by the PKI handshake may include sending receiving recipient device identification data including at least one of a recipient device identifier, one or more names of registered recipients, location data, and a code word associated with the package (410).

In some embodiments, the delivery confirmation instructions (422) further include instructions for generating, based on the recipient device identification data, a delivery confirmation report, appending to the delivery confirmation report an image file including an image of the package in the receiving zone, and transmitting the delivery confirmation report to the UAV control device (120) and the UAV server (120).

In some embodiments, the delivery confirmation instructions (422) further include instructions for storing the delivery confirmation report in a block of a blockchain data structure. Storing the delivery confirmation report in the block of the blockchain data structure may include signing the delivery confirmation report using a private key of the UAV (402).

In some embodiments, the delivery confirmation instructions (422) further include instructions for landing on the landing pad (435) of the recipient device (430) (see below) disposed in the receiving zone (452). If authentication of the receiving zone fails, an image of the receiving zone without releasing the package is captured, and the delivery confirmation data includes the image of the receiving zone showing that the receiving zone failed authentication and that the package was not delivered.

The system (400) of FIG. 4 further includes a recipient device (430) disposed in the receiving zone (452). The recipient device may include a landing pad (435) (which may also be coextensive with the receiving zone (452) for the UAV. The recipient device (430) further includes a camera (438), positioning circuitry (432) such as a GPS sensor, communication circuitry (436) for communicating with at least the UAV (402) and a wireless local area network, and a contact sensor (437) for detecting a UAV (402) or package (410) on the landing pad (435). The recipient device (430) further includes a processor (431) and a memory (439) storing operating instructions (434) that cause the processor to detect, by the recipient device disposed in a receiving zone for receiving a package, an unmanned aerial vehicle (UAV) in proximity to a receiving zone, authenticate, by the recipient device, the UAV, detect, by the recipient device, delivery of the package in the receiving zone, capture, by a camera of the recipient device, an image of the package, and generate, by the recipient device, delivery confirmation data including the image the package and location data obtained from a GPS sensor in the recipient device.

In some embodiments, the operating instructions (434) further include instructions for reading, by the camera (438), a machine-readable optical label (not shown) located on the UAV (402), the optical label including at least one of a Quick Response (QR) code and an April Tag, deriving an identification code from the optical label, and comparing the identification code to a list of known identification codes to identify the UAV (402).

In some embodiments, the operating instructions (434) further include instructions for establishing a communication channel with the UAV (402) through communication circuitry, performing, through the communication channel, a public key infrastructure (PKI) handshake using a public/private key pair of the recipient device, and exchanging identification data with the UAV (402) using a session key established by the PKI handshake. Exchanging identification data with the UAV (402) using the session key established by the PKI handshake may include receiving delivery identification data including at least one of a package identifier, a merchant identifier, a parcel delivery service identifier, and a UAV identifier from the UAV (402), and sending recipient device identification data including at least one of a recipient device identifier, one or more names of registered recipients, location data, and a code word associated with the package to the UAV (402).

In some embodiments, the operating instructions (434) further include instructions for generating, based on the delivery identification data, a delivery confirmation report, appending to the delivery confirmation report an image file including the image of the package and the location data, and transmitting the delivery confirmation report to a recipient of the package (410).

In some embodiments, the operating instructions (434) further include instructions for storing the delivery confirmation report in a block of a blockchain data structure. Storing the delivery confirmation report to the blockchain data structure may include signing the delivery confirmation report using the private key of the recipient device (430).

In some embodiments, the operating instructions (434) include instructions for reading, by the camera (438) a machine-readable optical label (not shown) located on the package (410), the optical label including at least one of a bar code, a Quick Response (QR) code and an April Tag, deriving an identification code from the optical label, and comparing the identification code to an identification code associated with the package (410).

For further explanation, FIG. 5 sets forth a block diagram illustrating a system (500) for confirmation of successful delivery by a UAV that is similar to the system (400) except that the recipient device is replace by a passive component such as an optical tag (510). The optical tag (510) may be, for example, a QR code or an April Tag. For example, the camera (112) of the UAV (402) reads the optical code (610) in the receiving zone (452) of the delivery destination (450). The processor (104) then extracts data from patterns that are present in both horizontal and vertical components of the image of the optical code captured by the camera (112). For example, an identification code may be derived from data represented by the QR code or the April Tag. The processor (104) of the UAV (402) compares the identification code to a code stored in a memory (406) of the UAV (402). For example, a merchant or vendor sending the package (410) may provide the UAV control device or UAV server with an identification code that uniquely identifies the receiving zone (452). The identification code may be provided, for example, by the recipient to the merchant or vendor.

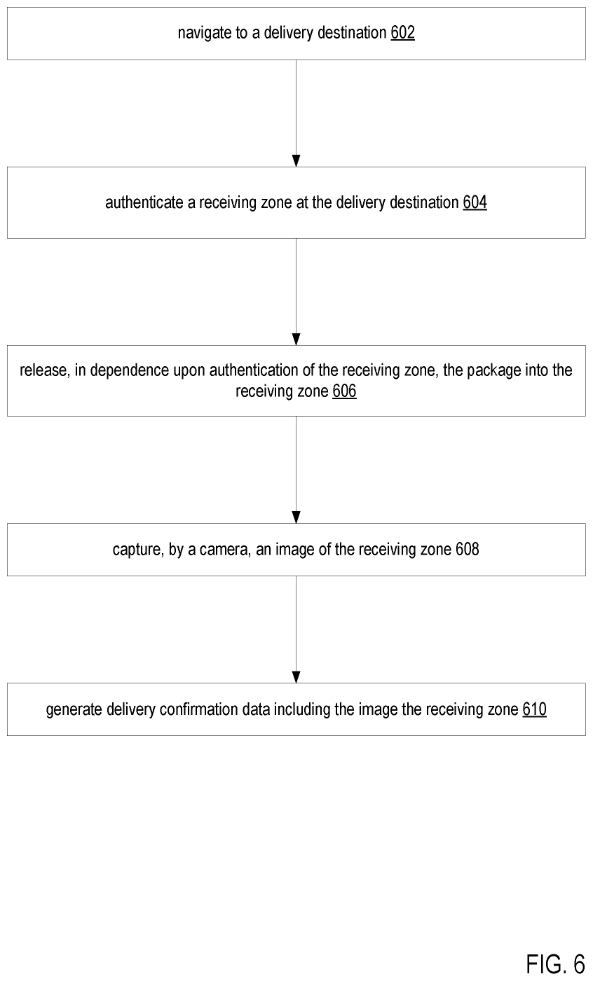

For further explanation, FIG. 6 sets forth a flow chart illustrating an exemplary method for confirmation of successful delivery by a UAV according to embodiments of the present invention that includes navigating (602), by a UAV carrying a package, to a delivery destination. Navigating (602), by a UAV carrying a package, to a delivery destination may be carried out by the UAV (402) navigating to delivery destination (450). The package (410) may originate from a merchant, vendor, fulfillment center, and the like for shipment to a recipient of the package associated with a delivery destination (450). The package (410) may be provided to the UAV (402) for transport to the delivery destination (450). For example, the control device (120) or the server (140) may provide the UAV (402) with route instructions (110) for navigating to the delivery destination (450). The package (410) may be attached to UAV (402) as payload and carried by a payload carrying device such as a grappling hook (not shown). The package (410) may be carried by the UAV (402) using other mechanisms that will be occur to those of skill in the art. The UAV (402) then travels, based on route instructions (110), to the delivery destination (450).

The method of FIG. 6 also includes authenticating (604), by the UAV, a receiving zone at the delivery destination. Authenticating (604), by the UAV, a receiving zone at the delivery destination may be carried out by the UAV (402) authenticating the receiving zone (452) at the delivery destination (450). For example, the merchant, vendor, or parcel delivery service may provide the UAV (402), via the control device (120) or server (140), with a code or other identification data that identifies the receiving zone (452) of the intended recipient of the package (410). The UAV (402) may authenticate the receiving zone (452) by comparing the code or identification data associated with the package (410) to a code or identification data obtained from the receiving zone (452) at the delivery destination (450). In some embodiments, the code or identification data obtained from the receiving zone (452) may be obtained from the recipient device (430). In other embodiments, the code or identification data obtained from the receiving zone (452) may be obtained from the optical tag (510) at the receiving zone (452).

The method of FIG. 6 also includes releasing (606), by the UAV in dependence upon authentication of the receiving zone, the package into the receiving zone. Releasing (606), by the UAV in dependence upon authentication of the receiving zone, the package into the receiving zone may be carried out by the UAV (402) releasing the package (410) into the receiving zone (452) at the delivery destination (450). For example, the package (410) may be released from a grappling hook or other payload carrying mechanism (not shown) onto the landing pad (435) of the recipient device (430). Also, the package (410) may be released from a grappling hook or other payload carrying mechanism (not shown) into a receptacle, such as a bag, box, or locker, disposed in the receiving zone (452). Further, the package (410) may be released from a grappling hook or other payload carrying mechanism (not shown) into an open area delimited by the boundary of the receiving zone.

The method of FIG. 6 also includes capturing (408), by a camera of the UAV, an image of the receiving zone. Capturing (408), by a camera of the UAV, an image of the receiving zone may be carried out by the camera (112) of the UAV (402) taking a picture of the package (410) in the receiving zone (452) at the delivery destination (450). For example, a photo of the package (410), after being released onto the landing pad (435) of the recipient device (430), may be captured by the camera (112) of the drone (402). In other embodiments, a photo of the package (410), after being released into the delimited receiving zone (452) or a receptacle (not shown) of the receiving zone (452), may be captured by the camera (112) of the drone (402).

In some embodiments, if authentication of the receiving zone fails, the UAV (402) may still capture an image of the receiving zone without releasing the package. The UAV (402) may append the image of the receiving zone to a delivery failure report that is sent to the UAV control device (120), the UAV server (140), or both. The delivery failure report may indicate that the receiving zone could not be authenticated along with GPS coordinates of the UAV, a timestamp, and the picture of the receiving zone as evidence indicating that delivery was attempted. The delivery failure report may also be added to the blockchain data structure containing route information.

The method of FIG. 6 also includes generating (610), by the UAV, delivery confirmation data including the image the receiving zone. Generating (610), by the UAV, delivery confirmation data including the image the receiving zone may be carried out by the UAV (402) generating a delivery confirmation report including the picture of the package (410) in the receiving zone (452) at the delivery destination (450). For example, the delivery confirmation report may include GPS coordinates where the package (410) was released, a timestamp, and recipient device identification data such as recipient device identifier, names of registered recipients, location data provided by the recipient device (430), a code word associated with the package (410), and/or a code word associated with the recipient device (430). The delivery confirmation report may be signed using a private key of the UAV (402).

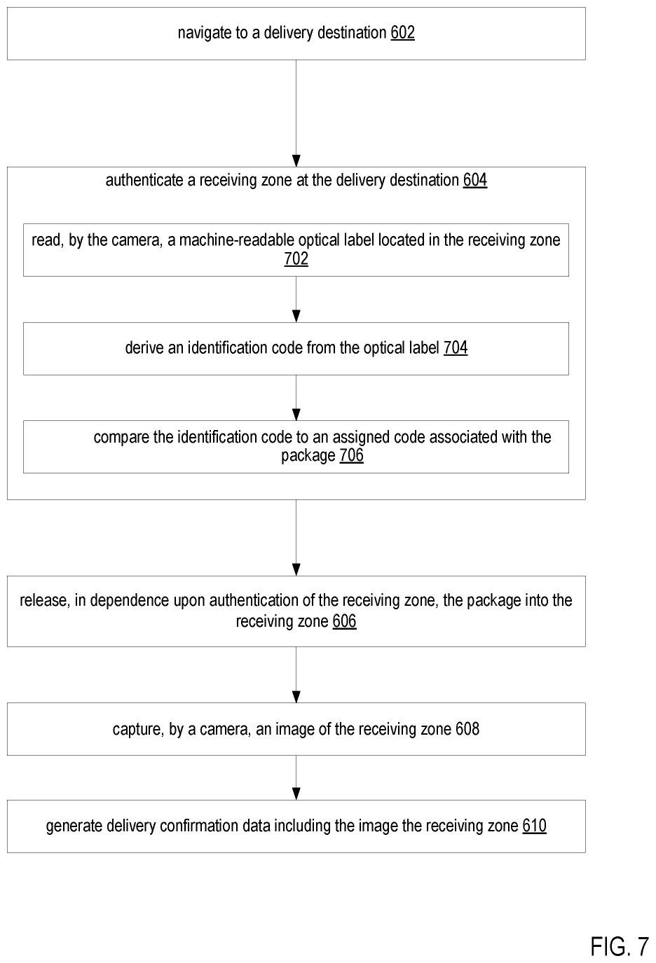

For further explanation, FIG. 7 sets forth a flow chart illustrating an exemplary method for confirmation of successful delivery by a UAV according to embodiments of the present invention. Like FIG. 6, FIG. 7 also includes navigating (602), by a UAV carrying a package, to a delivery destination, authenticating (604), by the UAV, a receiving zone at the delivery destination, releasing (606), by the UAV in dependence upon authentication of the receiving zone, the package into the receiving zone, capturing (408), by a camera of the UAV, an image of the receiving zone, and generating (610), by the UAV, delivery confirmation data including the image the receiving zone.

The method of FIG. 7 differs from the method of FIG. 6 in that authenticating (604), by the UAV, the receiving zone at the delivery destination includes reading (702), by the camera, a machine-readable optical label located in the receiving zone, the optical label including at least one of a Quick Response (QR) code and an April Tag. Reading (702), by the camera, a machine-readable optical label located in the receiving zone, the optical label including at least one of a Quick Response (QR) code and an April Tag may be carried out by the camera (112) of the UAV (402) reading the optical code (610) in the receiving zone (452) of the delivery destination (450).

The method of FIG. 7 also differs from the method of FIG. 6 in that authenticating (604), by the UAV, the receiving zone at the delivery destination further includes deriving (704) an identification code from the optical label. Deriving (704) an identification code from the optical label may be carried out by the processor (104) extracting data from patterns that are present in both horizontal and vertical components of the image of the optical code captured by the camera (112). For example, an identification code may be derived from data represented by the QR code or the April Tag.

The method of FIG. 7 also differs from the method of FIG. 6 in that authenticating (604), by the UAV, the receiving zone at the delivery destination further includes comparing (706) the identification code to an assigned code associated with the package. Comparing (706) the identification code to an assigned code associated with the package may be carried out by the processor (104) of the UAV (402) comparing the identification code to a code stored in a memory (406) of the UAV (402). For example, a merchant or vendor sending the package (410) may provide, directly or indirectly, the UAV control device (120) or UAV server (140) with an identification code that uniquely identifies the receiving zone (452). The identification code may be provided, for example, by the recipient to the merchant or vendor. The UAV control device (120) or UAV server (140) then provides the identification code to the UAV (402).

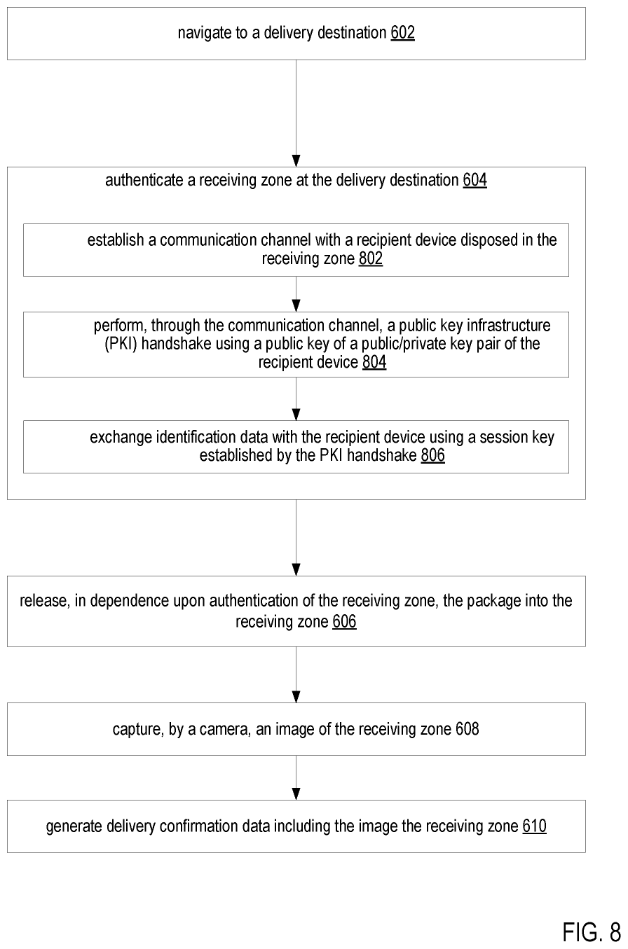

For further explanation, FIG. 8 sets forth a flow chart illustrating an exemplary method for confirmation of successful delivery by a UAV according to embodiments of the present invention. Like FIG. 6, FIG. 8 also includes navigating (602), by a UAV carrying a package, to a delivery destination, authenticating (604), by the UAV, a receiving zone at the delivery destination, releasing (606), by the UAV in dependence upon authentication of the receiving zone, the package into the receiving zone, capturing (408), by a camera of the UAV, an image of the receiving zone, and generating (610), by the UAV, delivery confirmation data including the image the receiving zone.

The method of FIG. 8 differs from the method of FIG. 6 in that authenticating (604), by the UAV, the receiving zone at the delivery destination includes establishing (802) a communication channel with a recipient device disposed in the receiving zone. Establishing (802) a communication channel with a recipient device disposed in the receiving zone may be carried out by the UAV (402) establishing a communication channel with the recipient device (430) in the receiving zone (452) using the communication circuitry (116). For example, a communication channel may be established through Near Field Communication, WiFi Direct, via a Near-me Network (NAN) or over a Wireless Personal Area Network (WPAN) such as IrDA, Wireless USB, Bluetooth, ZigBee, or other low-powered, short-distance wireless network technology.

The method of FIG. 8 also differs from the method of FIG. 6 in that authenticating (604), by the UAV, the receiving zone at the delivery destination further includes performing (804), through the communication channel, a public key infrastructure (PKI) handshake using a public key of a public/private key pair of the recipient device. Performing (804), through the communication channel, a public key infrastructure (PKI) handshake using a public key of a public/private key pair of the recipient device may be carried out by the UAV (402) performing a PKI handshake with the recipient device (430). For example, the recipient device (430) may provide the UAV (402) with a certificate that include the public key of a public/private key pair of the recipient device (430). The UAV (402) may validate the certificate with a certificate authority to confirm that the public key is associated with recipient device (430). The UAV (402) may then generate a session key, encrypt the session key using the public key of the recipient device (402), and send the encrypted session key to the recipient device (402). The recipient device may then response by providing a confirmation message encrypted using the session key that the session key has been received and that all future communication will be encrypted using the session key.

The method of FIG. 8 also differs from the method of FIG. 6 in that authenticating (604), by the UAV, the receiving zone at the delivery destination further includes exchanging (806) identification data with the recipient device using a session key established by the PKI handshake. Exchanging (806) identification data with the recipient device using a session key established by the PKI handshake may be carried out by the UAV (402) sending UAV delivery identification data to the recipient device (430) and receiving recipient device identification data from the recipient device (430). For example, the delivery identification data may include one or more of a package identifier, a merchant identifier, a parcel delivery service identifier, or a UAV identifier. In example embodiments, the package identifier may be an identifier assigned to the package by the merchant or vendor, such as an order number; the merchant identifier may be information indicating the merchant or vendor shipping the package; the parcel delivery service identifier may be a tracking number of the package assigned by the parcel delivery service; and the UAV identifier may be a unique identifier of the UAV (402). The recipient device identification data may include one or more of a recipient device identifier, names of registered recipients, location data, or a code word associated with the package. In example embodiments, a recipient device identifier may be a unique identifier of the recipient device (430) associated with a particular delivery address; names of registered recipients may be a list of names of people associated with the delivery address that is associated with the recipient device (430); location data may be current GPS coordinates of the recipient device (430) obtained from the GPS sensor (432) of the recipient device (430); and the code word associated with the package (410) may be a code word provided by the recipient of the package (410) to the merchant, vendor, or parcel delivery service for verifying that the recipient is the intended recipient.

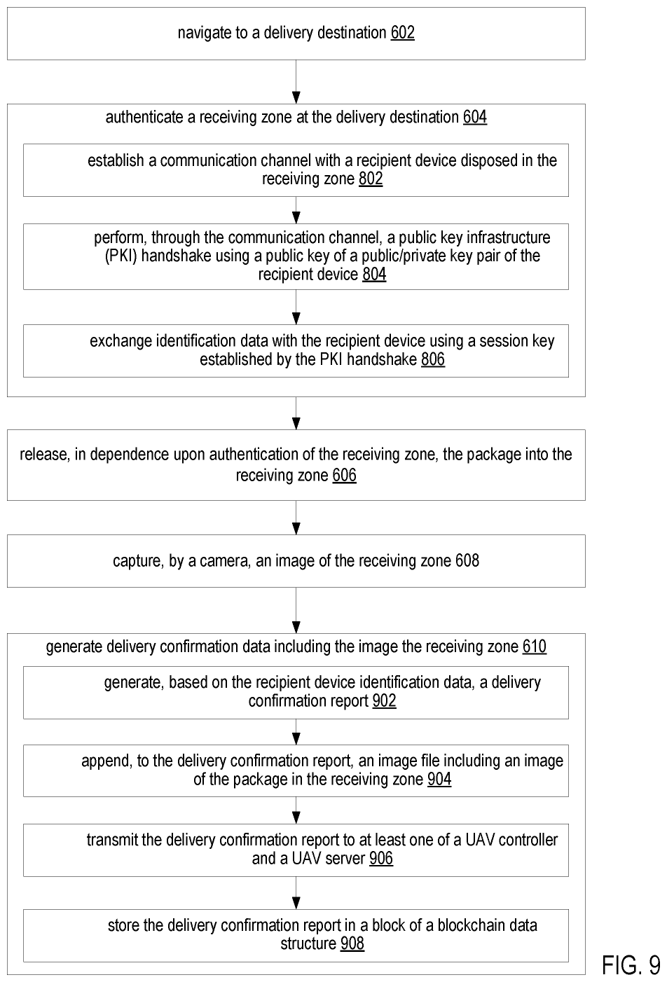

For further explanation, FIG. 9 sets forth a flow chart illustrating an exemplary method for confirmation of successful delivery by a UAV according to embodiments of the present invention. Like FIG. 8, FIG. 9 also includes navigating (602), by a UAV carrying a package, to a delivery destination, authenticating (604), by the UAV, a receiving zone at the delivery destination, releasing (606), by the UAV in dependence upon authentication of the receiving zone, the package into the receiving zone, capturing (608), by a camera of the UAV, an image of the receiving zone, and generating (610), by the UAV, delivery confirmation data including the image the receiving zone, wherein authenticating (604), by the UAV, a receiving zone at the delivery destination further includes exchanging (806) identification data with the recipient device using a session key established by the PKI handshake, performing (804), through the communication channel, a public key infrastructure (PKI) handshake using a public key of a public/private key pair of the recipient device, and exchanging (806) identification data with the recipient device using a session key established by the PKI handshake.

The method of FIG. 9 differs from the method of FIG. 8 in that generating (610), by the UAV, the delivery confirmation data including the image of the package in the receiving zone includes generating (902), based on the recipient device identification data, a delivery confirmation report. Generating (902), based on the recipient device identification data, a delivery confirmation report may be carried out by the UAV (402) compiling the recipient device identification data received from the recipient device (430) along with UAV data to generate the delivery confirmation report that is associated with the package (410). The UAV data may include, for example, GPS coordinates of the UAV (402) at the time of delivery, a timestamp indicating the time of delivery or time the report was generated, the UAV identifier, current weather data, and other data obtained from UAV sensors.

The method of FIG. 9 also differs from the method of FIG. 8 in that generating (610), by the UAV, the delivery confirmation data including the image of the package in the receiving zone further includes appending (904) to the delivery confirmation report an image file including an image of the package in the receiving zone. Appending (904) to the delivery confirmation report an image file including an image of the package in the receiving zone may be carried out by the processor (104) of the UAV (402) processing the image of the package (410) in the receiving zone (452) and attaching the processed image to the delivery confirmation report. For example, the processor (104) may compress the image or digitally sign the image (or a hash thereof) using the private key of the UAV (402).

The method of FIG. 9 also differs from the method of FIG. 8 in that generating (610), by the UAV, the delivery confirmation data including the image of the package in the receiving zone further includes transmitting (906) the delivery confirmation report to at least one of a UAV controller and a UAV server. Transmitting (906) the delivery confirmation report to at least one of a UAV controller and a UAV server may be carried out by the UAV (402) transmitting a message including the delivery confirmation report and processed image to the UAV control device (120), the UAV server (140), or both over the network (118) using communication circuitry (116).

The method of FIG. 9 also differs from the method of FIG. 8 in that generating (610), by the UAV, the delivery confirmation data including the image of the package in the receiving zone further includes storing (908) the delivery confirmation report in a block of a blockchain data structure. Storing (908) the delivery confirmation report in a block of a blockchain data structure may be carried out by the UAV (402) storing an instance of a blockchain data structure in local memory used to store, for example, route information associated with the UAV (402), and generating a new block containing the delivery confirmation report in the blockchain data structure.

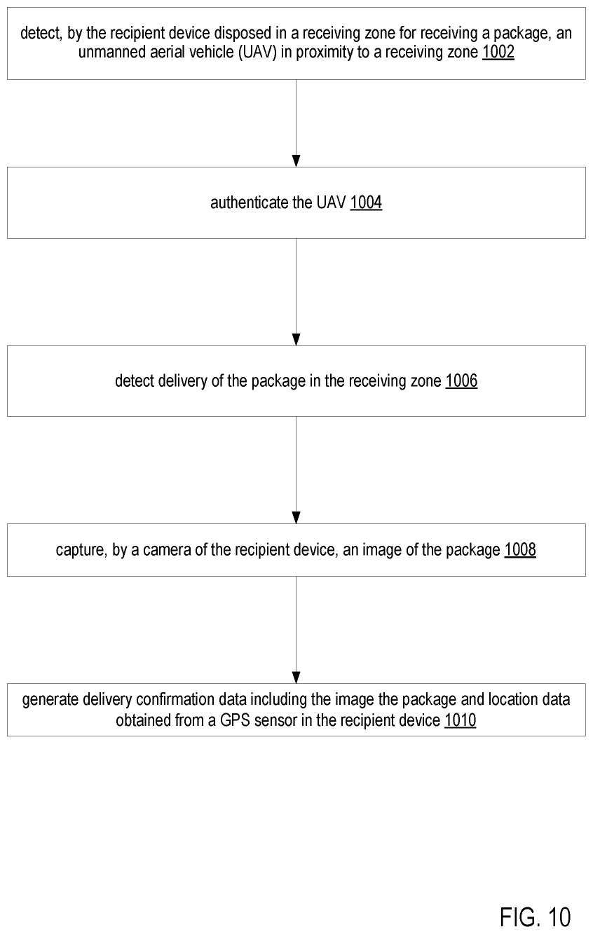

For further explanation, FIG. 10 sets forth a flow chart illustrating an exemplary method for confirmation of successful delivery by a UAV according to embodiments of the present invention that includes detecting (1002), by the recipient device disposed in a receiving zone for receiving a package, a UAV in proximity to a receiving zone. Detecting (1002), by the recipient device disposed in a receiving zone for receiving a package, a UAV in proximity to a receiving zone may be carried out by the recipient device (430) detecting that the UAV (402) is near or within the receiving zone (452). For example, the recipient device may detect, via a contact sensor (437) in the landing pad (435) of the recipient device (430), that the UAV (402) has landed on the landing pad (435). In some embodiments, the recipient device (430) may detect a signal transmitted by the UAV (402). For example, the UAV (402) may transmit a signal via Near Field Communication, via WiFi Direct, or via a Wireless Personal Area Network such as IrDA, Wireless USB, Bluetooth, ZigBee, or other low-powered, short-distance wireless network technology. In other embodiments, the recipient device (430) may transmit the signal via similar communication channels, and the UAV (402) is detected by its response to the transmitted signal.

The method of FIG. 10 also includes authenticating (1004), by the recipient device, the UAV. Authenticating (1004), by the recipient device, the UAV may be carried out by the recipient device (430) authenticating the UAV (402) by determining identity information associated with the UAV or the UAV payload and verifying that the UAV is trustworthy. For example, the recipient device may obtain a UAV identifier from the UAV (402) through communication with the UAV (402) or optically from identification data depicted on the UAV (402).

The method of FIG. 10 also includes detecting (1006), by the recipient device, delivery of the package in the receiving zone. Detecting (1006), by the recipient device, delivery of the package in the receiving zone may be carried out by the recipient device (430) determining that the package (410) has been left in the receiving zone (452). For example, the recipient device (430) may detect, via the contact sensor (437) in the landing pad (435) of the recipient device (430), that the package (410) has been placed on the landing pad (435). Also, the camera (438) of the recipient device may determine that the package (410) has been left in the receiving zone (452). In some embodiments, the contact sensor (437) may include a scale to confirm the weight of the package (410).

The method of FIG. 10 also includes capturing (1008), by a camera of the recipient device, an image of the package. Capturing (1008), by a camera of the recipient device, an image of the package may be carried out by the camera (438) of the recipient device (430) capturing an image of the package (110) in the receiving zone (452) and storing the image in the memory (439) of the recipient device. For example, the camera (438) may be located within the chassis of the recipient device (430) thus providing a “first person” view of the package (410) or remote from the chassis of the recipient device (430) thus providing a perspective view of the package (410) in the receiving zone (452). In one embodiment, instead of capturing an image by the camera (438) of the recipient device (430), an image of the package (110) in the receiving zone (452) may be received from the UAV (402). In this embodiment, the image of the package (410) is transmitted to the recipient device (430) by the UAV (402) as part of an exchange of information using the communication circuitry (116) of the UAV (402) and the communication circuitry (436) of the recipient device (430).

The method of FIG. 10 also includes generating (1010), by the recipient device, delivery confirmation data including the image the package and location data obtained from a GPS sensor in the recipient device. Generating (1010), by the recipient device, delivery confirmation data including the image the package and location data obtained from a GPS sensor in the recipient device may be carried out by the processor (431) of the recipient device generating a delivery confirmation report confirming the delivery of the package (410) that includes a timestamp, location data obtained from the GPS sensor (432) of the recipient device, the image of the package (410) in the receiving zone (452), and delivery identification data such as a package identifier, a merchant identifier, a parcel delivery service identifier, and/or a UAV identifier.

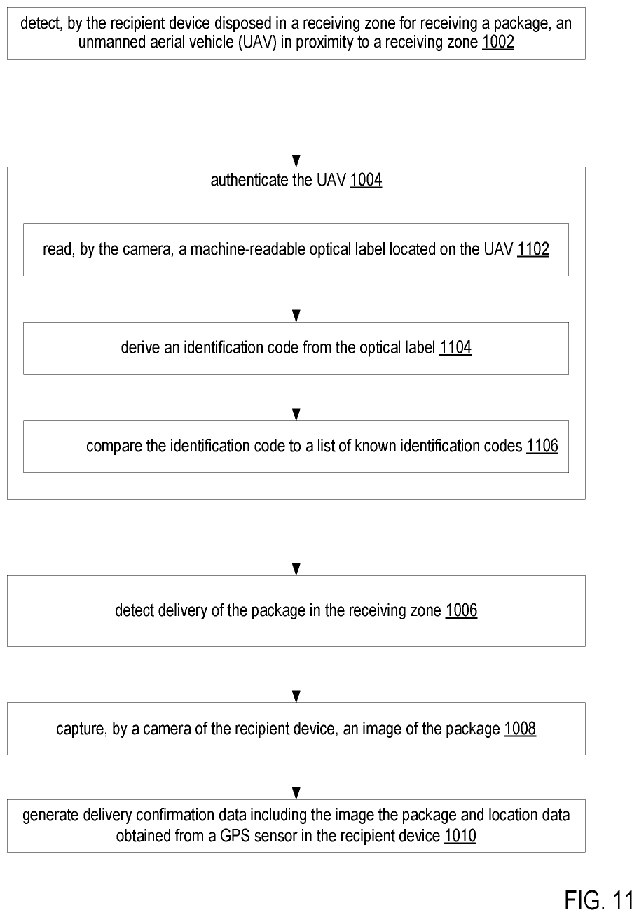

For further explanation, FIG. 11 sets forth a flow chart illustrating an exemplary method for confirmation of successful delivery by a UAV according to embodiments of the present invention. Like FIG. 10, FIG. 11 also includes detecting (1002), by the recipient device disposed in a receiving zone for receiving a package, a UAV in proximity to a receiving zone, authenticating (1004), by the recipient device, the UAV, detecting (1006), by the recipient device, delivery of the package in the receiving zone, capturing (1008), by a camera of the recipient device, an image of the package, generating (1010), by the recipient device, delivery confirmation data including the image the package and location data obtained from a GPS sensor in the recipient device.

The method of FIG. 11 differs from the method of FIG. 10 in that authenticating (1004), by the recipient device, the UAV includes reading (1102), by the camera, a machine-readable optical label located on the UAV, the optical label including at least one of a Quick Response (QR) code and an April Tag. Reading (1102), by the camera, a machine-readable optical label located on the UAV, the optical label including at least one of a Quick Response (QR) code and an April Tag may be carried out by the camera (438) of the recipient device (430) capturing an image of an optical code on the UAV (402).

The method of FIG. 11 also differs from the method of FIG. 10 in that authenticating (1004), by the recipient device, the UAV further includes deriving (1104) an identification code from the optical label. Deriving (1104) an identification code from the optical label may be carried out by the processor (431) of the recipient device (430) extracting data from patterns that are present in both horizontal and vertical components of the image of the optical code captured by the camera (438). For example, an identification code may be derived from data represented by the QR code or the April Tag.

The method of FIG. 11 also differs from the method of FIG. 10 in that authenticating (1004), by the recipient device, the UAV further comparing (1106) the identification code to a list of known identification codes. Comparing (1106) the identification code to a list of known identification codes may be carried out by the processor (431) of the recipient device (430) comparing the identification code to a list of identification codes. For example, a list of identification codes for registered UAVs, a list of identification codes for parcel delivery services, or a list of identification codes for particular UAV networks may be stored in the memory (439) of the recipient device (430).

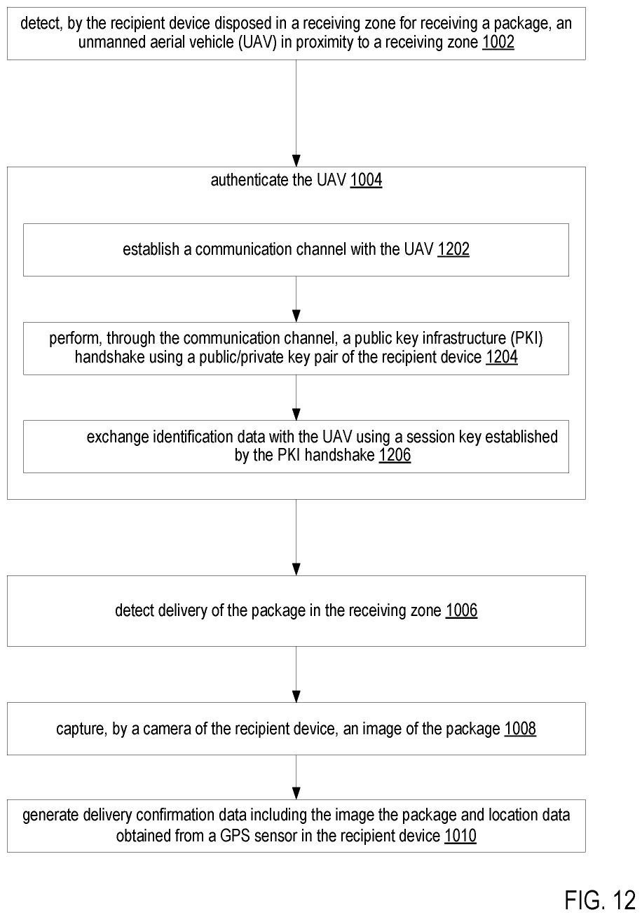

For further explanation, FIG. 12 sets forth a flow chart illustrating an exemplary method for confirmation of successful delivery by a UAV according to embodiments of the present invention. Like FIG. 10, FIG. 12 also includes detecting (1002), by the recipient device disposed in a receiving zone for receiving a package, a UAV in proximity to a receiving zone, authenticating (1004), by the recipient device, the UAV, detecting (1006), by the recipient device, delivery of the package in the receiving zone, capturing (1008), by a camera of the recipient device, an image of the package, generating (1010), by the recipient device, delivery confirmation data including the image the package and location data obtained from a GPS sensor in the recipient device.

The method of FIG. 12 differs from the method of FIG. 10 in that authenticating (1004), by the recipient device, the UAV includes establishing (1202) a communication channel with the UAV. Establishing (1202) a communication channel with the UAV may be carried out by the recipient device (430) discovering the UAV (402) via a communication protocol. For example, a communication channel may be established through Near Field Communication, WiFi Direct, via a Near-me Network (NAN) or over a Wireless Personal Area Network (WPAN) such as IrDA, Wireless USB, Bluetooth, ZigBee, or other low-powered, short-distance wireless network technology.

The method of FIG. 12 also differs from the method of FIG. 10 in that authenticating (1004), by the recipient device, the UAV further includes performing (1204), through the communication channel, a public key infrastructure (PKI) handshake using the public/private key pair of the recipient device. Performing (1204), through the communication channel, the public key infrastructure (PKI) handshake using the public/private key pair of the recipient device may be carried out by the recipient device (430) performing a PKI handshake with the UAV (402) using a public key and a private key stored in the memory (439) of the recipient device. For example, the recipient device (430) may provide the UAV (402) with a certificate that include the public key of a public/private key pair of the recipient device (430). The UAV (402) may validate the certificate with a certificate authority to confirm that the public key is associated with recipient device (430). The UAV (402) may then generate a session key, encrypt the session key using the public key of the recipient device (402), and send the encrypted session key to the recipient device (402). The recipient device may then response by providing a confirmation message encrypted using the session key that the session key has been received and that all future communication will be encrypted using the session key.

The method of FIG. 12 also differs from the method of FIG. 10 in that authenticating (1004), by the recipient device, the UAV further includes exchanging (1206) identification data with the UAV using a session key established by the PKI handshake. Exchanging (1206) identification data with the UAV using a session key established by the PKI handshake may be carried out by the recipient device (430) receiving delivery identification data from the UAV (402), and sending, to the UAV (402) recipient device identification data. For example, the delivery identification data may include one or more of a package identifier, a merchant identifier, a parcel delivery service identifier, or a UAV identifier. In example embodiments, the package identifier may be an identifier assigned to the package by the merchant or vendor, such as an order number; the merchant identifier may be information indicating the merchant or vendor shipping the package; the parcel delivery service identifier may be a tracking number of the package assigned by the parcel delivery service; and the UAV identifier may be a unique identifier of the UAV (402). The recipient device identification data may include one or more of a recipient device identifier, names of registered recipients, location data, or a code word associated with the package. In example embodiments, a recipient device identifier may be a unique identifier of the recipient device (430) associated with a particular delivery address; names of registered recipients may be a list of names of people associated with the delivery address that is associated with the recipient device (430); location data may be current GPS coordinates of the recipient device (430) obtained from the GPS sensor (432) of the recipient device (430); and the code word associated with the package (410) may be a code word provided by the recipient of the package (410) to the merchant, vendor, or parcel delivery service for verifying that the recipient is the intended recipient.

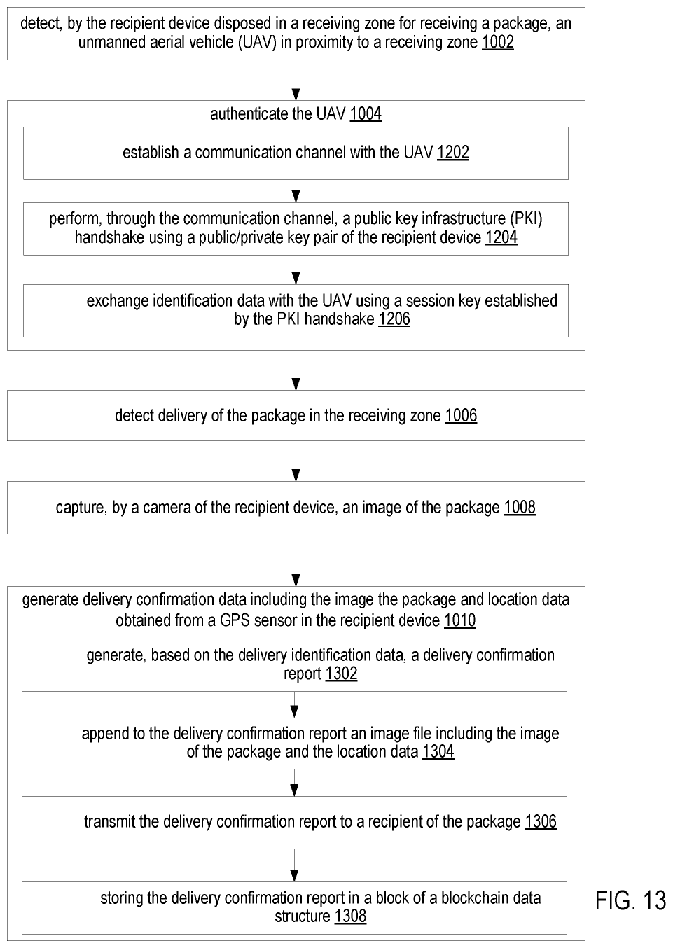

For further explanation, FIG. 13 sets forth a flow chart illustrating an exemplary method for confirmation of successful delivery by a UAV according to embodiments of the present invention. Like FIG. 12, FIG. 13 also includes detecting (1002), by the recipient device disposed in a receiving zone for receiving a package, a UAV in proximity to a receiving zone, authenticating (1004), by the recipient device, the UAV, detecting (1006), by the recipient device, delivery of the package in the receiving zone, capturing (1008), by a camera of the recipient device, an image of the package, generating (1010), by the recipient device, delivery confirmation data including the image the package and location data obtained from a GPS sensor in the recipient device, wherein authenticating (1004), by the recipient device, the UAV includes establishing (1202) a communication channel with the UAV, performing (1204), through the communication channel, a public key infrastructure (PKI) handshake using the public/private key pair of the recipient device, and exchanging (1206) identification data with the UAV using a session key established by the PKI handshake.

The method of FIG. 13 differs from the method of FIG. 12 in that generating (1010), by the recipient device, the delivery confirmation data including the image of the package and location data includes generating (1302), based on the delivery identification data, a delivery confirmation report. Generating (1302), based on the delivery identification data, a delivery confirmation report may be carried out by the processor (431) of the recipient device (430) compiling the delivery identification data received from the UAV (402) along with recipient device data to generate the delivery confirmation report that is associated with the package (410). The recipient device data may include, for example, GPS coordinates of the recipient device (430) at the time of delivery, a timestamp indicating the time of delivery or time the report was generated, a recipient device identifier, current weather data, package weight, and other data obtained from recipient device sensors (not shown).

The method of FIG. 13 also differs from the method of FIG. 12 in that generating (1010), by the recipient device, the delivery confirmation data including the image of the package and location data further includes appending (1304) to the delivery confirmation report an image file including the image of the package and the location data. Appending (1304) to the delivery confirmation report an image file including the image of the package and the location data may be carried out by the processor (431) of the recipient device (402) processing the image of the package (410) in the receiving zone (452) and attaching the processed image to the delivery confirmation report. For example, the processor (431) may compress the image or digitally sign the image (or a hash thereof) using the private key of the recipient device (430).

The method of FIG. 13 also differs from the method of FIG. 12 in that generating (1010), by the recipient device, the delivery confirmation data including the image of the package and location data further includes transmitting (1306) the delivery confirmation report to a recipient of the package. Transmitting (1306) the delivery confirmation report to a recipient of the package may be carried out by the processor (431) of the recipient device (430) sending, via communication circuitry in the recipient device (430), the confirmation report to the intended recipient of the package (410) that is registered with the recipient device (430). For example, a message may be sent to the recipient using a Wireless Local Area Network (WLAN) within the delivery destination (450).

The method of FIG. 13 also differs from the method of FIG. 12 in that generating (1010), by the recipient device, the delivery confirmation data including the image of the package and location data further includes storing (1308) the delivery confirmation report in a block of a blockchain data structure. Storing (1308) the delivery confirmation report in a block of a blockchain data structure may be carried out by the recipient device (430) storing an instance of a blockchain data structure in local memory, and generating a new block containing the delivery confirmation report with the package image in the blockchain data structure.

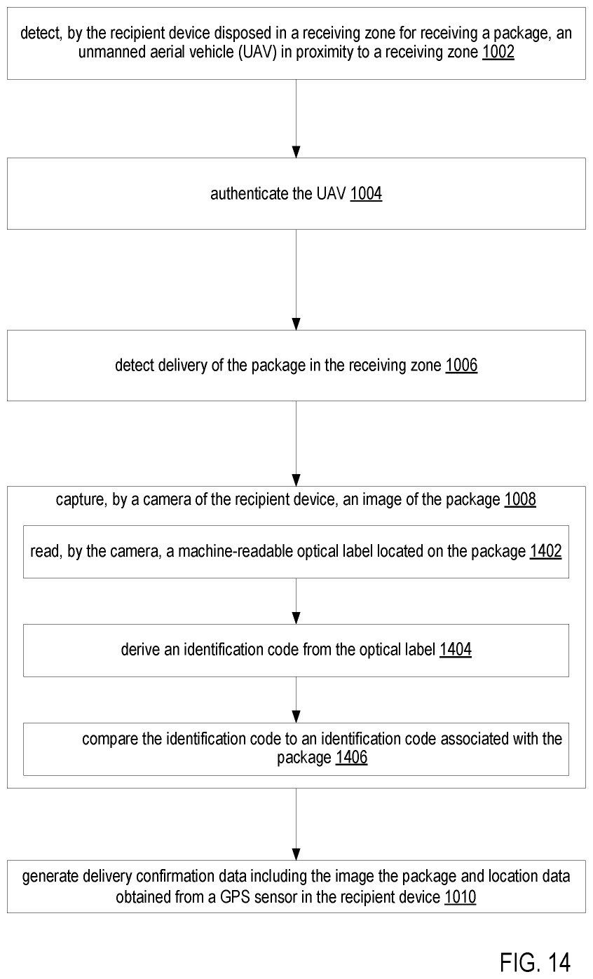

For further explanation, FIG. 14 sets forth a flow chart illustrating an exemplary method for confirmation of successful delivery by a UAV according to embodiments of the present invention. Like FIG. 10, FIG. 14 also includes detecting (1002), by the recipient device disposed in a receiving zone for receiving a package, a UAV in proximity to a receiving zone, authenticating (1004), by the recipient device, the UAV, detecting (1006), by the recipient device, delivery of the package in the receiving zone, capturing (1008), by a camera of the recipient device, an image of the package, generating (1010), by the recipient device, delivery confirmation data including the image the package and location data obtained from a GPS sensor in the recipient device.

The method of FIG. 14 differs from the method of FIG. 10 in that capturing (1008), by the camera of the recipient device, the image of the package includes reading (1402), by the camera, a machine-readable optical label located on the package, the optical label including at least one of a bar code, a Quick Response (QR) code and an April Tag. Reading (1402), by the camera, a machine-readable optical label located on the package, the optical label including at least one of a bar code, a Quick Response (QR) code and an April Tag may be carried out by the camera (438) of the recipient device (430) capturing an image of an optical code on the package (410).

The method of FIG. 14 also differs from the method of FIG. 10 in that capturing (1008), by the camera of the recipient device, the image of the package further includes deriving (1104) an identification code from the optical label. Deriving (1104) an identification code from the optical label may be carried out by the processor (431) of the recipient device (430) extracting data from patterns that are present in both horizontal and vertical components of the image of the optical code on the package (410) captured by the camera (438). For example, an identification code may be derived from data represented by the QR code or the April Tag.

The method of FIG. 14 also differs from the method of FIG. 10 in that capturing (1008), by the camera of the recipient device, the image of the package further includes comparing (1406) the identification code to an identification code associated with the package. Comparing (1406) the identification code to an identification code associated with the package may be carried out by the processor (431) of the recipient device (430) comparing the identification code to an identification code associated with the package that was received from the merchant or vendor, or from a parcel delivery service. For example, the identification code associated with the package (410), such as an order number or tracking number, may be compared to the identification code in the optical label that is affixed to the package (410).

Exemplary embodiments of the present invention are described largely in the context of a fully functional computer system for route planning for a UAV. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of for confirmation of successfully delivery by an unmanned aerial vehicle (UAV), the method comprising:
navigating, by a UAV carrying a package, to a delivery destination;
authenticating, by the UAV, a receiving zone at the delivery destination;
releasing, by the UAV in dependence upon authentication of the receiving zone, the package into the receiving zone;
capturing, by a camera of the UAV, an image of the receiving zone; and
generating, by the UAV, delivery confirmation data including the image the receiving zone.

2. The method of claim 1, wherein authenticating, by the UAV, the receiving zone at the delivery destination includes:
reading, by the camera, a machine-readable optical label located in the receiving zone, the optical label including at least one of a Quick Response (QR) code and an April Tag;
deriving an identification code from the optical label; and
comparing the identification code to an assigned code associated with the package.

3. The method of claim 1, wherein authenticating, by the UAV, the receiving zone at the delivery destination includes:
establishing a communication channel with a recipient device disposed in the receiving zone;
performing, through the communication channel, a public key infrastructure (PKI) handshake using a public key of a public/private key pair of the recipient device; and
exchanging identification data with the recipient device using a session key established by the PKI handshake.

4. The method of claim 3, wherein exchanging identification data with the recipient device using the session key established by the PKI handshake includes:
sending delivery identification data including at least one of a package identifier, a merchant identifier, a parcel delivery service identifier, and a UAV identifier to the recipient device; and
receiving recipient device identification data including at least one of a recipient device identifier, one or more names of registered recipients, location data, and a code word associated with the package.

5. The method of claim 4, wherein generating, by the UAV, the delivery confirmation data including the image of the package in the receiving zone includes:
generating, based on the recipient device identification data, a delivery confirmation report;
appending to the delivery confirmation report an image file including an image of the package in the receiving zone; and
transmitting the delivery confirmation report to at least one of a UAV controller and a UAV server.

6. The method of claim 4, wherein generating, by the UAV, the delivery confirmation data including the image of the package in the receiving zone includes:
generating, based on the recipient device identification data, a delivery confirmation report;
appending to the delivery confirmation report an image file including an image of the package in the receiving zone; and
storing the delivery confirmation report in a block of a blockchain data structure.

7. The method of claim 6, wherein storing the delivery confirmation report in the block of the blockchain data structure includes signing the delivery confirmation report using a private key of the UAV.

8. The method of claim 1 further comprising landing on a landing pad of a recipient device disposed in the receiving zone.

9. The method of claim 1 further comprising:
if authentication of the receiving zone fails, capturing an image of the receiving zone without releasing the package; and
wherein the delivery confirmation data including the image of the receiving zone indicates that the receiving zone failed authentication and that the package was not delivered.

10. A device for confirmation of successfully delivery by an unmanned aerial vehicle (UAV) comprising:
a processor; and
a memory storing instruction that when executed cause the processor to:
navigate to a delivery destination;
authenticate a receiving zone at the delivery destination;
release, in dependence upon authentication of the receiving zone, the package into the receiving zone;
capture, by a camera of the UAV, an image of the receiving zone; and
generate delivery confirmation data including the image the receiving zone.

11. A method of for confirmation of successfully delivery by an unmanned aerial vehicle (UAV), the method comprising:
detecting, by the recipient device disposed in a receiving zone for receiving a package, an unmanned aerial vehicle (UAV) in proximity to a receiving zone;
authenticating, by the recipient device, the UAV;
detecting, by the recipient device, delivery of the package in the receiving zone;
capturing, by a camera of the recipient device, an image of the package; and
generating, by the recipient device, delivery confirmation data including the image the package and location data obtained from a GPS sensor in the recipient device.

12. The method of claim 11, wherein authenticating, by the recipient device, the UAV:
reading, by the camera, a machine-readable optical label located on the UAV, the optical label including at least one of a Quick Response (QR) code and an April Tag;
deriving an identification code from the optical label; and
comparing the identification code to a list of known identification codes.

13. The method of claim 11, wherein authenticating, by the recipient device, the UAV includes:
establishing a communication channel with the UAV;
performing, through the communication channel, a public key infrastructure (PKI) handshake using a public/private key pair of the recipient device; and
exchanging identification data with the UAV using a session key established by the PKI handshake.

14. The method of claim 13, wherein exchanging identification data with the UAV using the session key established by the PKI handshake includes:
receiving delivery identification data including at least one of a package identifier, a merchant identifier, a parcel delivery service identifier, and a UAV identifier from the UAV; and
sending recipient device identification data including at least one of a recipient device identifier, one or more names of registered recipients, location data, and a code word associated with the package to the UAV.

15. The method of claim 14, wherein generating, by the recipient device, the delivery confirmation data including the image of the package and location data includes:
generating, based on the delivery identification data, a delivery confirmation report;
appending to the delivery confirmation report an image file including the image of the package and the location data; and
transmitting the delivery confirmation report to a recipient of the package.

16. The method of claim 14, wherein generating, by the recipient device, the delivery confirmation data including the image of the package and the location data includes:
generating, based on the delivery identification data, a delivery confirmation report;
appending to the delivery confirmation report an image file including the image of the package; and
storing the delivery confirmation report in a block of a blockchain data structure.

17. The method of claim 16, wherein storing the delivery confirmation report to the blockchain data structure includes signing the delivery confirmation report using the private key of the recipient device.

18. The method of claim 11, wherein capturing, by the camera of the recipient device, the image of the package includes:
reading, by the camera, a machine-readable optical label located on the package, the optical label including at least one of a bar code, a Quick Response (QR) code and an April Tag;
deriving an identification code from the optical label; and
comparing the identification code to an identification code associated with the package.

19. The method of claim 11, wherein detecting, by the recipient device disposed in a receiving zone for receiving a package, the UAV in proximity to the receiving zone includes detecting, by a sensor in the recipient device, that the UAV has landed on a landing pad of the recipient device.

20. A device for confirmation of successfully delivery by an unmanned aerial vehicle (UAV) comprising:
a processor; and
a memory storing instruction that when executed cause the processor to:
detect, by the device disposed in a receiving zone for receiving a package, a UAV in proximity to a receiving zone;
authenticate the UAV;
detect delivery of the package in the receiving zone;
capture, by a camera of the device, an image of the package; and
generate delivery confirmation data including the image the package and location data obtained from a GPS sensor in the device.
